(19) United States
(12) Patent Application Publication
(10) Pub. No.: US 2010/0300630 A1
(43) Pub. Date: Dec. 2, 2010

(54) Cellular Shade

(75) Inventor: Che-Min Su, Changhua County (TW)

Correspondence Address: Che-Min SU, P.O. Box 44-295, Taipei, 10699, omitted

(73) Assignee: Ching Feng Home Fashion Co., Ltd., Changhua County (TW)

(21) Appl. No.: 12/472,358

(22) Filed: May 26, 2009

(51) Int. Cl. E06B 9/24

(52) U.S. Cl. 160/84.05

(57) ABSTRACT

A cellular shade includes stacked and interconnected cells each including a firs strip and a second strip. The first strip includes a first half and a second half extended from the first half. The second half of the first strip includes a first connective portion extended from the first half thereof at an angle, a second connective portion extended from the first connective portion thereof at another angle and a pleat formed between the first and second connection portions of the second half thereof. The second strip includes a first half connected to the first half of the first strip thereof and a second half connected to the first half of the first strip of an adjacent one of the cells.

### FIELD OF THE INVENTION

The present invention relates to a shade and, more particularly, to a cellular shade.

### RELATED PRIOR ART

Blinds, curtains and shades are used near doors and windows for shading and/or decoration. There are various shades such as Venetian blinds, curtains, Roman curtains and cellular shades. A blind, curtain or shade is generally collapsible.

As disclosed in U.S. Pat. No. 5,193,601 or shown in FIG. 11, a cellular shade includes strips in a first color and other strips in a second color for aesthetic purposes. The strips in the first color are alternatively arranged with the strips in the second color. Each of the strips is made into a cell. The cells are generally connected to one another with glue for example and located between an upper beam and a lower beam. Two cords are used to move the lower beam towards and away from the upper beam, i.e., to collapse and extend the cellular shade. However, some sections of the cords that are supposed to be concealed by the cells might be seen accidentally because of poor gluing. Moreover, some of the cells might not be expanded because of poor gluing.

The present invention is therefore intended to obviate or at least alleviate the problems encountered in prior art.

### SUMMARY OF THE INVENTION

It is the primary objective of the present invention to provide an aesthetic and reliable cellular shade.

To achieve the foregoing objective, the cellular shade includes stacked and interconnected cells each including a firs strip and a second strip. The first strip includes a first half and a second half extended from the first half. The second half of the first strip includes a first connective portion extended from the first half thereof at an angle, a second connective portion extended from the first connective portion thereof at another angle and a pleat formed between the first and second connection portions of the second half thereof. The second strip includes a first half connected to the first half of the first strip thereof and a second half connected to the first half of the first strip of an adjacent one of the cells.

Other objectives, advantages and features of the present invention will become apparent from the following description referring to the attached drawings.

### BRIEF DESCRIPTION OF THE DRAWINGS

The present invention will be described via detailed illustration of the preferred embodiment versus the prior art referring to the drawings.

FIG. 1 shows a process for folding a first strip for use in a cell of a cellular shade according to the preferred embodiment of the present invention.

FIG. 2 is a perspective view of the first strip after the folding process shown in FIG. 1.

FIG. 3 is another perspective view of the first strip shown in FIG. 2.

FIG. 4 shows a process for folding a second strip for use in a cell of a cellular shade according to the preferred embodiment of the present invention.

FIG. 5 is a perspective view of the second strip after the folding process shown in FIG. 4.

FIG. 6 is another perspective view of the second strip shown in FIG. 5.

FIG. 7 is a partial, exploded view of the cell including the first strip shown in FIGS. 2 and 3 and the second strip shown in FIGS. 5 and 6.

FIG. 8 is a partial, perspective view of the cellular shade including cells as the one shown in FIG. 7.

FIG. 9 is a partial, side view of the cellular shade shown in FIG. 8.

FIG. 10 is a perspective view of the cellular shade including the cells as the one shown in FIG. 8.

FIG. 11 is a partial, side view of a conventional cellular shade.

### DETAILED DESCRIPTION OF THE INVENTION

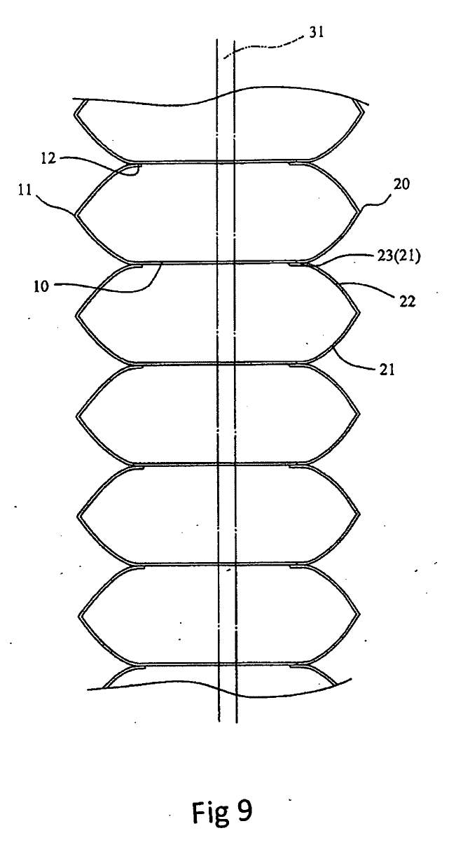

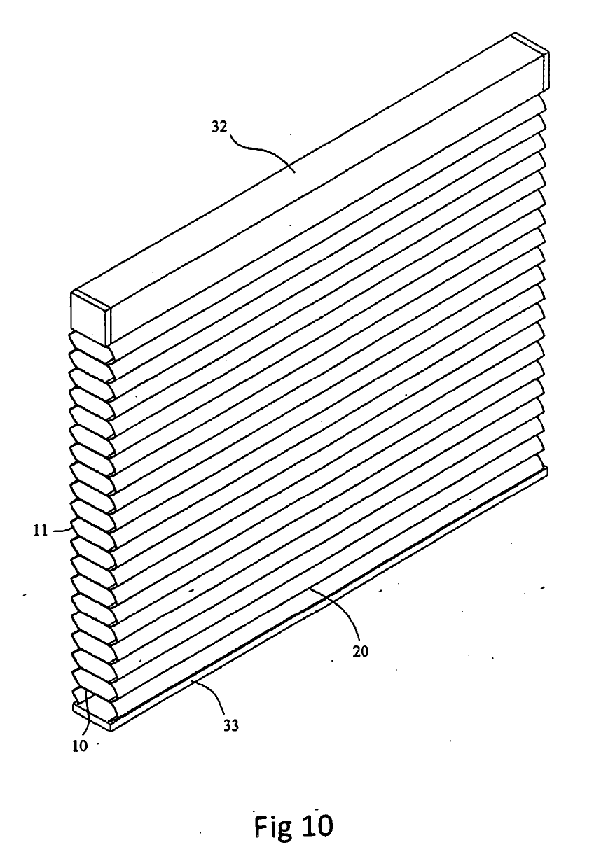

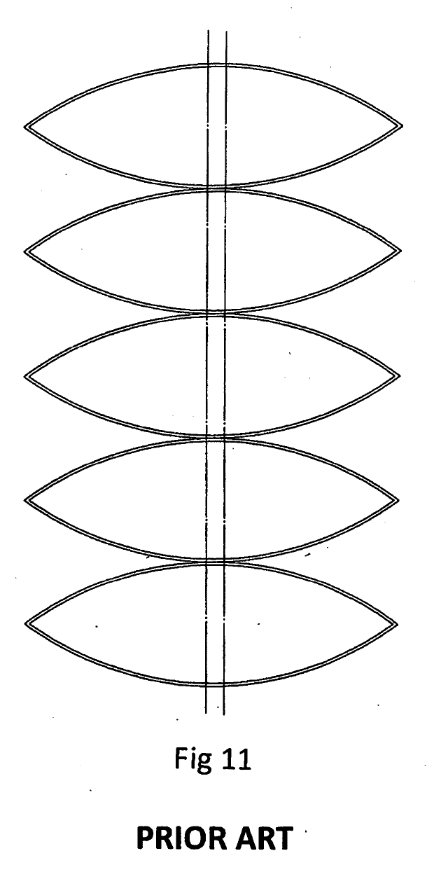

Referring to FIG. 10, a cellular shade 1 includes cells, an upper beam 32 and a lower beam 33 according the preferred embodiment of the present invention. The cells are connected to one another and located between the upper beam 32 and the lower beam 33. Referring to FIGS. 8 and 9, each of the cells is made of a first strip 10 in a first color and a second strip 20 in a second color.

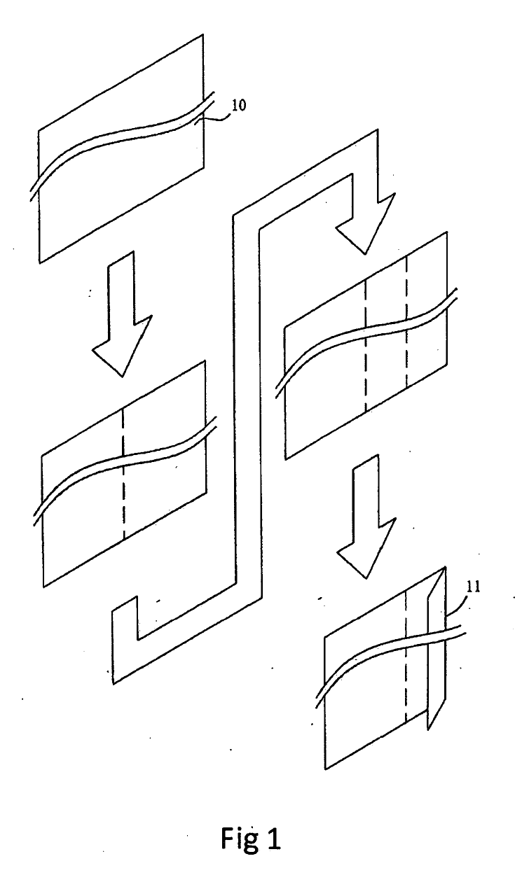

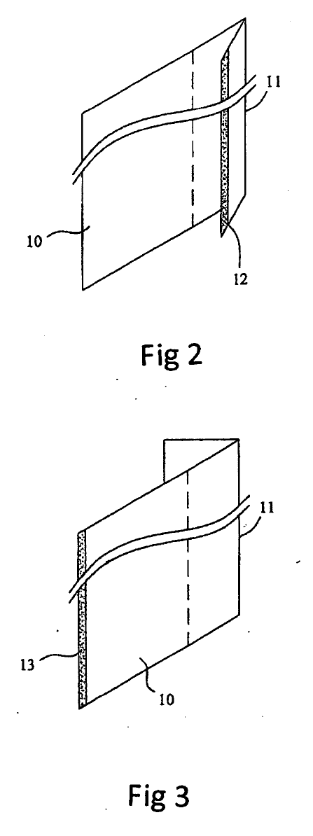

Referring to FIGS. 1 through 3, there is shown a process for shaping the first strip 10 of each of the cells. The first strip 10 is folded, thus dividing the first strip 10 into two halves. The first half of the first strip 10 is retained planar. The second half of the first strip 10 is folded, thus forming a pleat 11 with a first connective portion extended from the first half of the first strip 10 at an angle and a second connective portion extended from the first connective portion at an angle. Glue 13 is provided on the first half of the first strip 10 while glue 12 is provided on the second connective portion of the pleat 11.

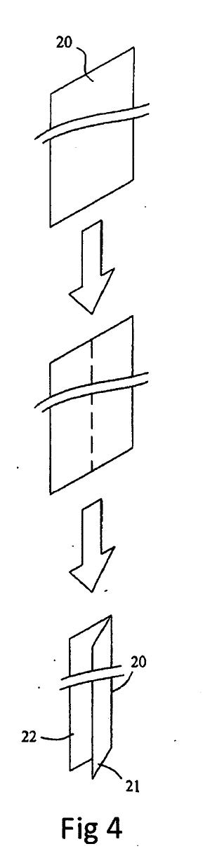

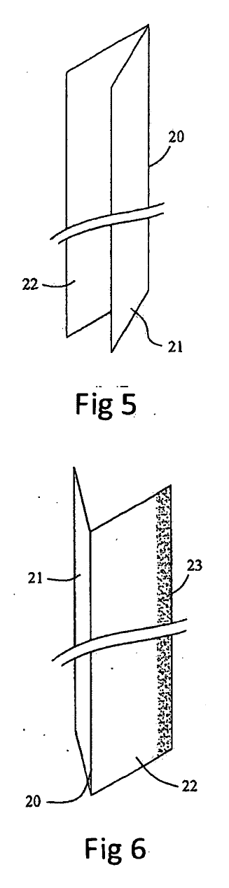

Referring to FIGS. 4 through 6, there is shown a process for shaping the second strip 20 of each of the cells. Before the shaping, the size of the second strip 20 is about half the size of the first strip 10. The second strip 20 is folded, thus dividing the second strip 20 into halves 21 and 22 and forming a pleat between the halves 21 and 22 thereof. Glue 23 is only provided on the half 22 of the second strip 20.

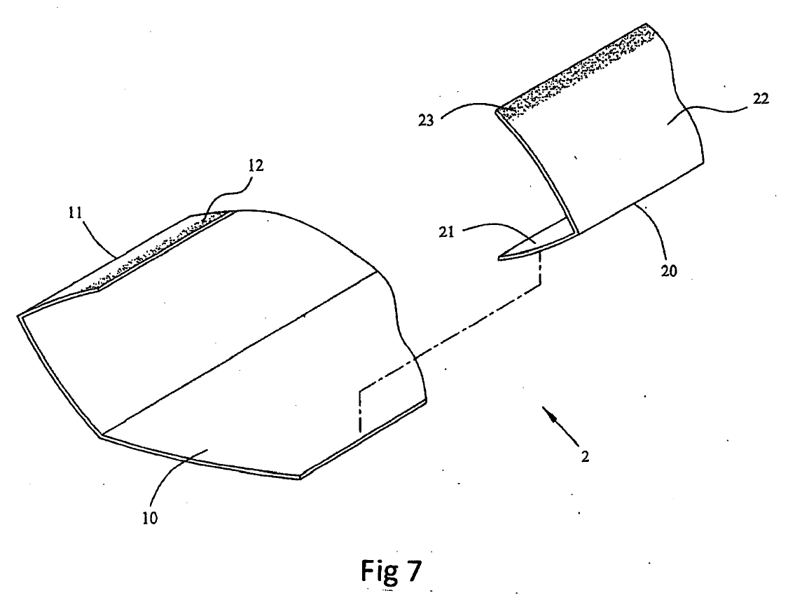

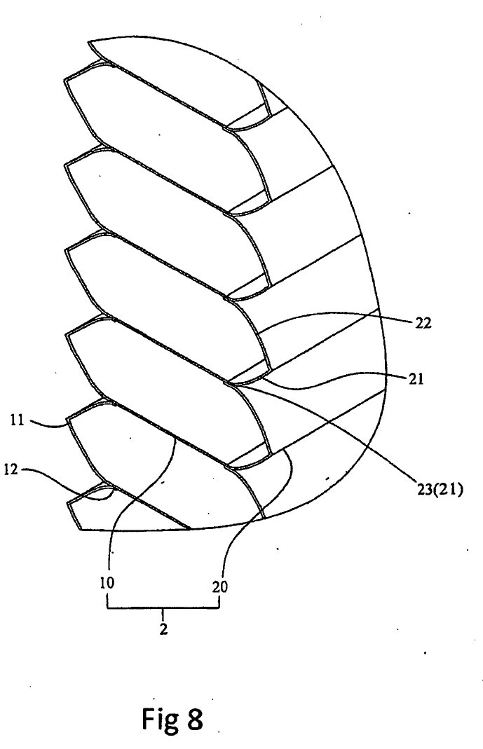

Referring to FIGS. 7 through 9, the second connective portion of the first strip 10 of each cell is connected to the first connective portion of the first strip 10 of an upper cell with the glue 12. The half 22 of the second strip 20 of the cell is connected to an internal side of the first half of the first strip 10 of the cell with the glue 23. The half 21 of the second strip 20 of the cell is connected to an external side of the first half of the first strip 10 of the upper cell with the glue 13.

Apertures are made in the first half of the firs strip 10 of each cell so that cords 31 can be inserted through the apertures. The cords 31 are connected to the upper beam 32 and the lower beam 33. The cords 31 are operable to move the lower beam 33 towards and away from the upper beam 32, i.e. to collapse and extend the cellular shade.

The cellular shade of the present invention exhibits advantages over the cellular shades discussed in the RELATED PRIOR ART. Firstly, sections of the cords 31 that are supposed to be concealed with the cells are not visible. Secondly, all of the cells are extensible if so desired.

In another embodiment, glue 13 is omitted while glue 23 is provided on both of the halves 21 and 22 of the second strip 20. The second connective portion of the first strip 10 of each cell is connected to the first connective portion of the first strip 10 of an upper cell with the glue 12. The first half of the second strip 20 of each cell is connected to an internal side of the first half of the first strip 10 of the cell with the glue 23. The second half of the second strip 20 of each cell is connected to an external side of the first half of the firs strip 10 of an upper cell with the glue 23.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A cellular shade comprising stacked and interconnected cells each comprising:
a first strip comprising a first half and a second half extended from the first half and made with a first connective portion extended from the first half thereof at an angle, a second connective portion extended from the first connective portion thereof at another angle and a pleat formed between the first and second connection portions of the second half thereof; and
a second strip comprising a first half connected to the first half of the first strip thereof and a second half connected to the first half of the first strip of an adjacent one of the cells.

2. The cellular shade according to claim 1, wherein some of the strips are in a first color while the other strips are in a second color, and the strips in the first color are alternatively arranged with the strips in the second color.

3. The cellular shade according to claim 1, wherein an external side of the first half of the second strip is connected to an internal side of the first half of the first strip.

4. The cellular shade according to claim 1, wherein an external side of the second half of the second strip is connected to an external side of the first half of the first strip of an adjacent one of the cells.

5. The cellular shade according to claim 1, wherein glue is provided on at least one of the first half of the first strip and the second connective portion of the second half of the first strip before the connection.

6. The cellular shade according to claim 1, wherein glue is provided on at least one of the first and second halves of the second strip before the connection.
